(19) United States
(12) Patent Application Publication
(10) Pub. No.: US 2004/0004426 A1
(43) Pub. Date: Jan. 8, 2004

(54) Colour picture tube and deflection system with improved imaging properties

(75) Inventor: Andreas Ehrhardt, Plochingen (DE)

Correspondence Address: Timothy E. Newholm, BOYLE, FREDRICKSON, NEWHOLM, STEIN & GRATZ, S.C., 250 Plaza, Suite 1030, 250 East Wisconsin Avenue, Milwaukee, WI, 53202, US

(73) Assignee: Matsushita Display Devices (Germany) GmbH

(21) Appl. No.: 10/453,463

(22) Filed: Jun. 3, 2003

(30) Foreign Application Priority Data
Jul. 4, 2002 (EP) 02014858.1

(51) Int. Cl. H01J 29/70

(52) U.S. Cl. 313/431

(57) ABSTRACT

The present invention therefore relates to a colour picture tube and a deflection system for a colour picture tube comprising a rectangular fluorescent screen and an in-line electron beam generator system. An in-line electron beam generator system generates a plurality of electron beams which essentially extend in a common plane and which are directed onto the fluorescent screen. For correcting an east-west inward pincushion distortion, convergence magnets are arranged in a first plane on the colour picture tube and in the deflection system of a colour picture tube, respectively, and geometry magnets are arranged in a second plane which is different from said first plane. The planes of the convergence magnets and of the geometry magnets are each oriented perpendicular to the direction of the electron beams. It follows that the present invention provides a colour picture tube in the case of which a conventional east-west inward pincushion distortion can be corrected without using a circuit for additionally modulating the horizontal deflection current and which can be produced at a reasonable price in spite of the improved imaging properties.

### BACKGROUND OF THE INVENTION

1. Field of the Invention

The present invention relates generally to a colour picture tube and especially to colour picture tubes having an improved deflection unit for reduced aberrations.

2. Description of the Related Art

The deflection of electron beams in a colour picture tube is effected by magnetic fields produced by horizontal and vertical deflection coils of a funnel-shaped deflection unit. The deflection unit, which is mounted on a colour picture tube, essentially comprises two pairs of coils and a ferrite core. A first pair of coils produces a magnetic field which deflects the electron beams produced by electron beam generator systems in the horizontal direction (X direction), whereas the additional pair of coil causes a vertical deflection (Y direction). The ferrite core encompasses both pairs of coils and serves to return the magnetic flux. The deflection unit may additionally comprise convergence magnets and soft-magnetic field formers. Such a deflection unit produces on the screen of the colour picture tube a self-converging image without north-south raster distortion.

Modern colour picture tubes include electron beam generator systems in a so-called in-line arrangement in which the electron beam generator systems for the various colour components are arranged in one plane. The axes of the electron beams generated in systems of this kind extend on the screen in a coplanar and converging mode.

The colour picture tube and the deflection system of the present invention concern an improvement of the east-west inward pincushion geometrical distortion. Normally, such an east-west distortion is reduced or compensated by modulating the horizontal deflection current. FIG. 1 shows an east-west inward pincushion distortion which still exists after a conventional modulation of the horizontal deflection current. By means of such a correction, an east-west distortion of the outer vertical lines is eliminated. An east-west inward pincushion of the inner vertical lines is, however, not eliminated.

This still existing east-west inward pincushion is normally corrected, if necessary, with the aid of an extra current modulation circuit which is integrated in a deflection circuit. This conventional solution is disadvantageous insofar as such a circuit entails a great additional expenditure and extra costs. In other cases, no such additional circuit is used and the east-west inward pincushion distortion is therefore put up with.

### OBJECTS AND SUMMARY OF THE INVENTION

It is therefore the object of the present invention to provide a colour picture tube and a deflection unit for colour picture tubes which eliminate east-west inward pincushion distortion in a simple manner and at a reasonable price.

This object is achieved by the features of claim 1 for a colour picture tube and by the features of claim 18 for a deflection unit.

According to the present invention, convergence magnets are arranged on the outer surface of the colour picture tube and the deflection unit, respectively, in a first plane which extends perpendicular to the direction of the electron beams, and geometry magnets are arranged in a second plane which is different from said first plane and which extends perpendicular to the direction of the electron beams.

According to one aspect of the present invention, the convergence magnets and the geometry magnets are arranged in the deflection system of a colour picture tube. A simple structural design and a simple production of the colour picture tube according to the present invention can be achieved in this way.

According to an advantageous embodiment of the present invention, a total of four convergence magnets and/or geometry magnets are symmetrically arranged in said first and second planes, respectively. In this way, each quadrant of the image to be reproduced on the fluorescent screen can be corrected easily.

In accordance with another advantageous embodiment of the present invention, the plane in which the geometry magnets are arranged is located closer to the fluorescent screen than the plane in which the convergence magnets are arranged. This has the effect that the geometry magnets can easily be secured to the end of the funnel-shaped deflection system which faces the fluorescent screen, e.g. in the area of the coil winding heads.

A particularly advantageous influence on the field by means of the convergence magnets will be achieved, when said convergence magnets are arranged closer to the vertical axis of the colour picture tube than to the horizontal axis thereof.

In addition, a particularly advantageous correction by means of the geometry magnets will be achieved, when said geometry magnets are arranged closer to the horizontal axis of the colour picture tube than to the vertical axis thereof.

A particularly good correction will be achieved, when the convergence magnets are arranged approx. at an angle of 60° to the common plane in which the electron beams extend and when the geometry magnets are arranged at an angle of approx. 30° to the common plane of the electron beams. In this way, a particularly efficient correction of the geometry distortion can be achieved with little outlay.

Preferred embodiments of the present invention are disclosed in the subclaims.

### BRIEF DESCRIPTION OF THE DRAWINGS

The invention will now be explained in detail with reference to the drawings, in which

FIG. 1 shows an east-west inward pincushion distortion which still exists after a correction of an east-west distortion of the outer vertical lines.

FIG. 2 shows schematically the structural design of a colour picture tube.

FIG. 3 shows a schematic view of the first plane of a deflection system according to the present invention for a colour picture tube with the convergence magnets arranged at specific angular positions.

FIG. 4 shows a schematic view of a fluorescent screen of a colour picture tube according to the present invention after a correction of the east-west inward pincushion distortion according to FIG. 1 with an additional correction by geometry magnets.

FIG. 5 shows a schematic representation of a fluorescent screen of a colour picture tube according to the present invention with an east-west inward pincushion distortion that has been reduced in accordance with the present invention.

FIG. 6 shows a schematic view of a second plane of the deflection system according to the present invention for a colour picture tube with the geometry magnets arranged at specific angular positions.

FIG. 7 shows, in a side view, the structural design of the deflection system of FIG. 3 according to the present invention.

### DETAILED DESCRIPTION OF THE PREFERRED EMBODIMENTS

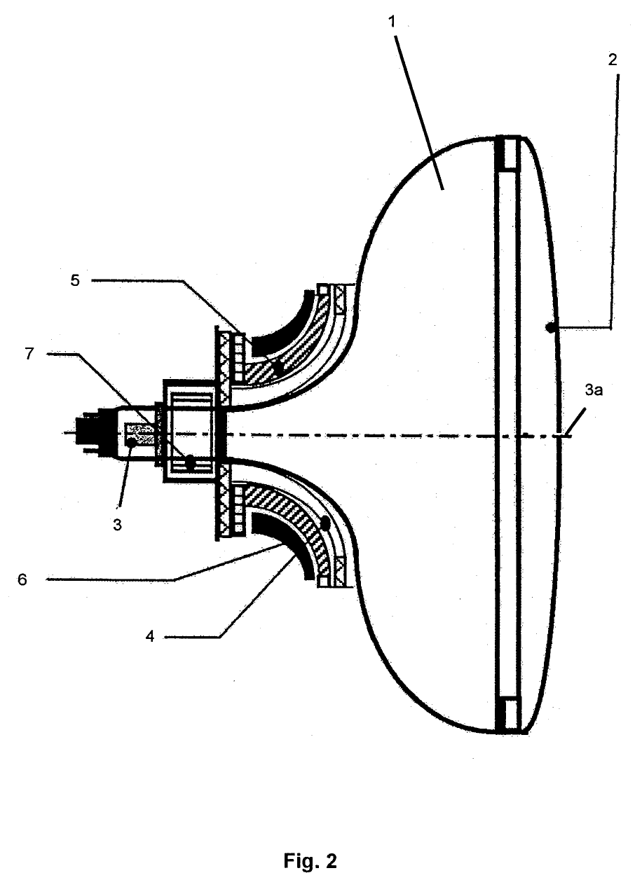

FIG. 2 shows a sectional view of a colour picture electron beam tube 1. The colour picture tube is provided with a fluorescent layer on the inner side of the screen area 2 and has an electron beam generator system 3 in the neck of the colour picture tube. The electron beam generator system 3 is an in-line electron beam generator system. The term in-line electron beam generator system stands for an electron beam generator system generating preferably three electron beams which extend in a common plane 3a and which are directed onto the fluorescent screen 2.

On the outer side of the glass body of the colour picture tube, a deflection system is mounted. The deflection system comprises a pair of horizontal deflection coils 4, a pair of vertical deflection coils 5 and a ferrite core 6 enclosing both deflection coils 4,5. Such a deflection system having an essentially funnel-shaped structural design causes the electron beams generated by the electron beam generator system 3 to be deflected in the X direction and in the Y direction. The deflection unit additionally comprises magnets and, if desired, soft-magnetic field formers so that a self-converging image without north-south raster distortion is produced on the fluorescent screen 2.

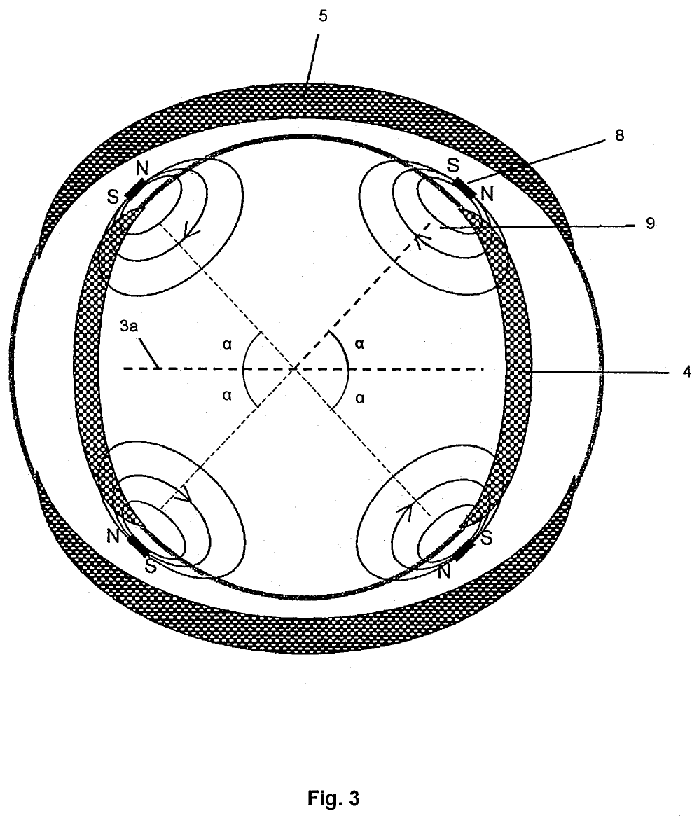

FIG. 3 shows a schematic view of a first plane of the deflection system according to the present invention in the direction of the Z axis of the colour picture tube. The vertical deflection coils are designated by reference numeral 5, the horizontal deflection coils are designated by reference numeral 4. In addition, four symmetrically arranged convergence magnets 8 are shown in this view. Preferably, the four convergence magnets 8 are all arranged approximately in the direction of the screen corners. The convergence magnets 8 are preferably located closer to the vertical axis (Y) than to the horizontal axis (X) of the colour picture tube.

Preferably, the convergence magnets 8 are all arranged at an angle α of approx. 60° to the in-line plane 3a. Depending on the structural design and the shape of the colour picture tube, the additional convergence magnets 8 can be positioned within an angular range from 45° to 70° for the angle α, preferably within an angular range between 50° and 60°.

By means of these convergence magnets 8, a local magnetic field is generated which, due to its position and its dimensioning and due to the fact that the three electron beams are specially positioned relative to one another in this area, causes a deflection of the electron beams to different extents. This has the effect that, in the corners on the right-hand side of the screen, mainly a shift of red and green towards the left relative to blue takes place. On the left-hand side, a shift of blue and green towards the right relative to red takes place in a corresponding manner. In addition, a change in the geometry of the horizontal and vertical lines on the screen takes place.

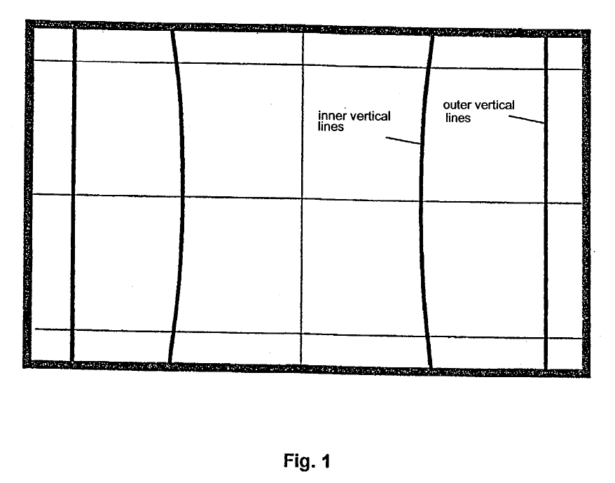

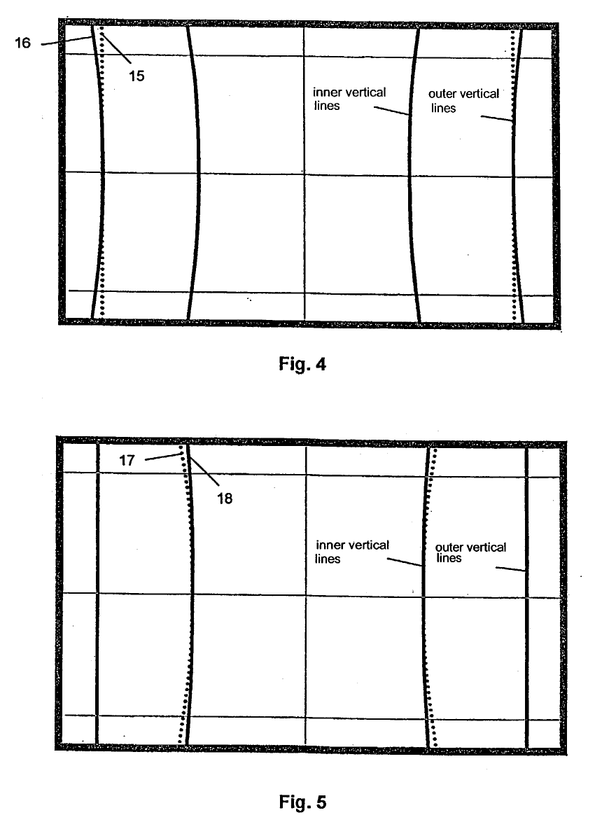

This kind of convergence and geometry change caused by the convergence magnets 8 permits the use of additional geometry magnets for correcting these resultant aberrations, whereby the east-west inward pincushion distortion will be improved. According to the present invention, this has the effect that the east-west pincushion distortion of the outer vertical lines shown in FIG. 1 is increased due to the use of the convergence and geometry magnets in the case of an unchanged modulation of the horizontal deflection current. The resultant distortion is shown in FIG. 4. The solid lines shown in FIG. 4 indicate the east-west pincushion distortion caused when the horizontal deflection current is modulated in a conventional manner (according to FIG. 1) and when geometry magnets are additionally used. For the purpose of comparison, the outer vertical lines which are representative of cases in which no additional geometry magnets are used (FIG. 1) are shown as dotted lines.

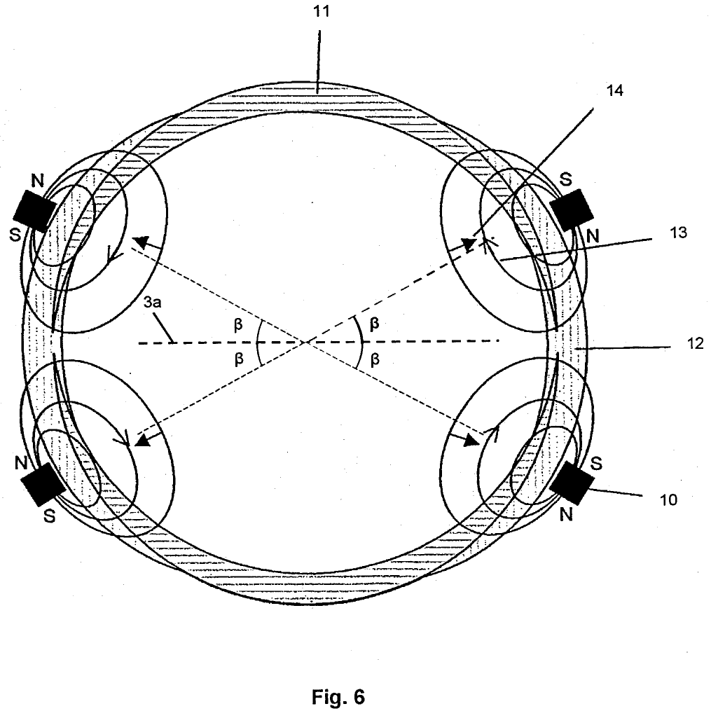

By means of a slight variation of the modulation of the horizontal deflection current, an improvement of the east-west inward pincushion distortion can be achieved. The result is shown in FIG. 5. In comparison with the inward pincushion distortion of the inner vertical lines in FIG. 1, the east-west inward pincushion distortion has been improved markedly (solid lines). For the purpose of comparison, the original inward pincushion distortion of the inner vertical lines according to FIG. 1 is shown by a dotted line.

FIG. 6 shows how the additional geometry magnets are arranged according to the present invention in the case of a preferred embodiment. FIG. 6 shows a schematic view of a second plane of the deflection system according to the present invention in the direction of the Z axis of the colour picture tube. The horizontal coil winding heads of the deflection system are designated by reference numeral 11, the vertical coil winding heads by reference numeral 12. In addition, four symmetrically arranged geometry magnets 10 are shown in this representation. Preferably, the geometry magnets 10 are located closer to the horizontal axis of the colour picture tube than to the vertical axis thereof. In a preferred embodiment, the four geometry magnets 10 are all positioned at an angle β of approx. 30° to the in-line plane 3a. Depending on the structural design and the shape of the colour picture tube, the geometry magnets 10 can be positioned within an angular range from 10° to 45° for the angle β, preferably within an angular range between 20° and 40°.

The plane in which the geometry magnets 10 are arranged is preferably located closer to the fluorescent screen than the plane in which the convergence magnets 8 are arranged.

The way in which the convergence magnets 8 are positioned in accordance with the present invention has the effect that the three electron beams, which extend horizontally side by side, are deflected to different degrees by the magnetic field generated by a respective convergence magnet 8. A suitable displacement of the electron beams relative to one another can be adjusted by the polarity and the dimensioning of the magnetic field for the purpose of convergence correction.

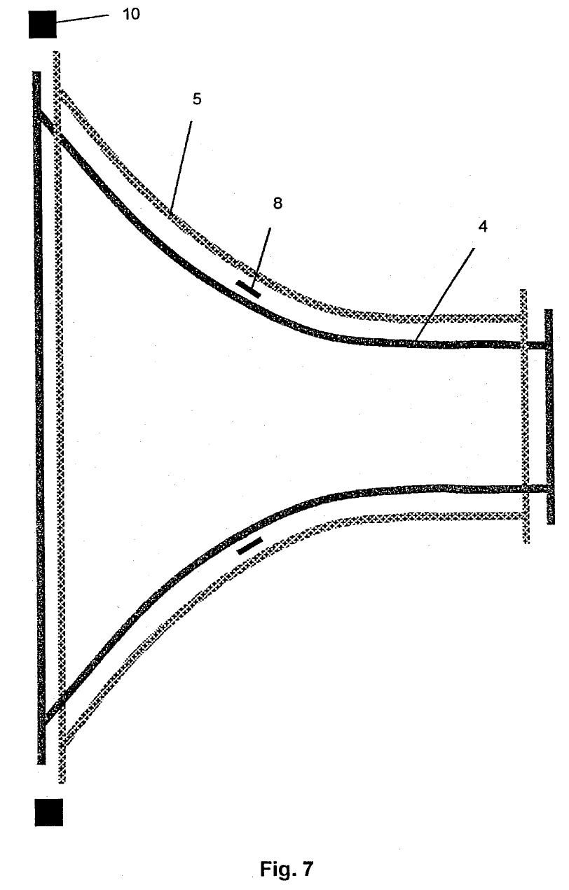

The convergence magnets 8 are preferably mounted in the Z direction of the colour picture tube in a central plane with respect to the deflection system. Such an arrangement is shown in FIG. 7. The correction magnets 8 are here preferably provided on the horizontal coils 4 of the deflection system, which consists of horizontal coils 4 and vertical coils 5. By displacing the plane of the convergence magnets 8 in the Z direction of the colour picture tube, the influence of the magnetic fields 9 on the electron beams can be varied.

Preferably, the additional geometry magnets 10 are arranged in the front area of the deflection system, e.g. in the area of the large coil winding heads.

The degree of the improvement of the east-west inward pincushion distortion can be influenced within a wide range via the position, the size and the strength of the convergence and geometry magnets.

It follows that the present invention relates to a colour picture tube and a deflection system for a colour picture tube comprising a rectangular fluorescent screen and an in-line electron beam generator system. An in-line electron beam generator system generates a plurality of electron beams which essentially extend in a common plane and which are directed onto the fluorescent screen. For correcting an east-west inward pincushion distortion, convergence magnets are arranged in a first plane on the colour picture tube and in the deflection system of a colour picture tube, respectively, and geometry magnets are arranged in a second plane which is different from said first plane. The planes of the convergence magnets and of the geometry magnets are each oriented perpendicular to the direction of the electron beams.

Hence, the present invention provides a colour picture tube in the case of which a conventional east-west inward pincushion distortion can be corrected without using a circuit for additionally modulating the horizontal deflection current and which can be produced at a reasonable price in spite of the improved image-forming properties.

1. A colour picture tube, comprising:
a rectangular fluorescent screen,
an in-line electron beam generator for generating a plurality of electron beams which essentially extend in a common plane and which are directed onto the fluorescent screen, and
convergence magnets and geometry magnets mounted on the outer surface of the colour picture tube, said convergence magnets being essentially arranged in a first plane which extends perpendicular to the direction of the electron beams, and the geometry magnets being essentially arranged in a second plane being different from said first plane and extending perpendicular to the direction of the electron beams.

2. A colour picture tube according to claim 1, wherein the convergence magnets are arranged in the area of a deflection unit mounted on the outer surface of the colour picture tube for deflecting the electron beams.

3. A colour picture tube according to claim 2, wherein the deflection unit comprises a horizontal coil and a vertical coil and that the convergence magnets are mounted on the horizontal coil.

4. A colour picture tube according to claim 1, wherein a total of four convergence magnets are symmetrically arranged in said first plane.

5. A colour picture tube according to claim 1, wherein a total of four geometry magnets are symmetrically arranged in said second plane.

6. A colour picture tube according to claim 1, wherein, relative to the position of said first plane, said second plane is arranged closer to said fluorescent screen.

7. A colour picture tube according to claim 1, wherein said second plane is located in the deflection unit area which is arranged closer to said fluorescent screen.

8. A colour picture tube according to claim 7, wherein said second plane is arranged in the area of the large coil winding heads of said deflection unit.

9. A colour picture tube according to claim 1, wherein said first plane is arranged in a middle position in the Z direction with respect to the horizontal coil of said deflection unit.

10. A colour picture tube according to claims 1, wherein the respective convergence magnets in said first plane are arranged closer to the vertical axis of the colour picture tube than to the horizontal axis thereof.

11. A colour picture tube according to claim 10, wherein the convergence magnets in said first plane are each arranged at an angle between 45° and 80° to the common plane in which the electron beams extend.

12. A colour picture tube according to claim 11, wherein the convergence magnets in said first plane are each arranged at an angle between 50° and 70° to the common plane in which the electron beams extend.

13. A colour picture tube according to claim 12, wherein the convergence magnets in said first plane are each arranged at an angle of approx. 60° to the common plane in which the electron beams extend.

14. A colour picture tube according to claim 1, wherein the respective geometry magnets in said second plane are arranged closer to the horizontal axis of the colour picture tube than to the vertical axis thereof.

15. A colour picture tube according to claim 1, wherein the geometry magnets in said second plane are each arranged at an angle between 10° and 45° to the common plane in which the electron beams extend.

16. A colour picture tube according to claim 11, wherein the geometry magnets in said second plane are each arranged at an angle between 10° and 45° to the common plane in which the electron beams extend.

17. A colour picture tube according to claim 14, wherein the geometry magnets in said second plane are each arranged at an angle between 10° and 45° to the common plane in which the electron beams extend.

18. A colour picture tube according to claim 15, wherein the geometry magnets in said second plane are each arranged at an angle between 20° and 40° to the common plane in which the electron beams extend.

19. A colour picture tube according to claim 16, wherein the geometry magnets in said second plane are each arranged at an angle of approx. 30° to the common plane in which the electron beams extend.

20. A deflection unit for a colour picture tube, comprising:
a rectangular fluorescent screen,
an in-line electron beam generator system for generating a plurality of electron beams which essentially extend in a common plane and which are directed onto said fluorescent screen of the colour picture tube, and
convergence magnets and geometry magnets mounted on the deflection system, said convergence magnets being essentially arranged in a first plane which extends perpendicular to the direction of the electron beams, and said geometry magnets (10) being essentially arranged in a second plane which is different from said first plane and which extends perpendicular to the direction of the electron beams.

21. A deflection unit according to claim 20, wherein, said second plane is located in the area of the deflection unit which is arranged closer to the fluorescent screen.

22. A deflection unit according to claim 20, wherein said second plane is arranged in the area of the coil winding heads of the deflection unit.

23. A deflection unit according to claim 20, wherein said first plane is arranged in a middle position in the Z direction with respect to the horizontal coil of the deflection unit.

24. A deflection unit according to said claim 20, wherein the respective convergence magnets in said first plane are arranged closer to the vertical axis of the colour picture tube than to the horizontal axis thereof.

25. A deflection unit according to claim 20, wherein the respective geometry magnets in said second plane are arranged closer to the horizontal axis of the colour picture tube than to the vertical axis thereof.
